(19) United States
(12) Patent Application Publication
(10) Pub. No.: US 2023/0348231 A1
(43) Pub. Date: Nov. 2, 2023

(54) ACCESS CONTROL ARRANGEMENT, MOBILE DEVICE, CONVEYOR SYSTEM, AND METHOD FOR CONTROLLING ACCESS IN CONVEYOR SYSTEM

(71) Applicant: KONE Corporation, Helsinki (FI)

(72) Inventors: Sathishraja KALAIYARASAN, Chennai (IN); Gowsalya SHANMUGASUNDARAM, Chennai (IN)

(73) Assignee: KONE Corporation, Helsinki (FI)

(21) Appl. No.: 18/219,294

(22) Filed: Jul. 7, 2023

Related U.S. Application Data
(63) Continuation of application No. PCT/EP2021/055755, filed on Mar. 8, 2021.

(51) Int. Cl. B66B 13/16; B66B 1/46; B66B 25/00; G07C 9/10

(52) U.S. Cl. CPC B66B 13/165; B66B 1/468; B66B 25/003; G07C 9/10; B66B 2201/4676

(57) ABSTRACT

An access control arrangement of a conveyor system, a mobile device, a conveyor system, and a method for controlling access in a conveyor system are disclosed. The conveyor system includes a manual key-operated access mechanism operable via a key-hole by a key. The access control arrangement includes a communication device for communicating with a mobile device, and a blocking member configured to cover the keyhole in a first position for blocking external access, and to expose the keyhole in a second position, the blocking member being movable between the first and the second positions. The access control arrangement is configured to lock the blocking member in the first position, and release it from the first position in response to receiving a release signal by the communication device.

### FIELD OF THE INVENTION

The present invention relates in general to conveyor systems, such as to elevators, escalators, or moving walkways, and/or to control units, panels, and/or hatches, or (landing) doors thereof. In particular, however not exclusively, the present invention concerns controlling access in conveyor systems in order to hinder unauthorized access to loca-tions, such as to control panel or unit, or hoistway, to which access is restricted, for example, for safety reasons.

### BACKGROUND

In normal elevator operation, landing doors and car doors are opened in tandem to enable access from the landing to the elevator car at the landing, and vice versa. However, in special operation, such as in elevator maintenance operation, there may be a need for service personnel to enter the elevator hoistway. Typically, service personnel will release landing door manually to enter hoistway pit or a car roof. This is possible by operating a manual access mechanism when there is no adjacent elevator car blocking the hoistway entrance.

Landing door access mechanism may be designed such that manual release is possible by operating a special physical key in a compatible keyhole of the landing door, which is disposed, for example, to a landing door frame or top track.

However, the physical keys for the access to the control units are prone to manipulation or mishandling by any person in addition to the fact that these keys are not necessarily unique. Similar situation is also with control units and panels of escalators and moving walkways. This may be a safety issue to the persons operating the keys without prior knowledge of the systems.

### SUMMARY

An objective of the present invention is to provide an access control arrangement, a mobile device, a conveyor system, and a method for controlling access in a conveyor system. Another objective of the present invention is that the access control arrangement, the mobile device, the conveyor system, and the method hinders unauthorized usage of devices and/or components of the conveyor system to which access is restricted, such as by a door or a hatch, for example, by a landing door of an elevator. Still another objective is to protect the access control arrangement against vandalism.

The objectives of the invention are reached by provide an access control arrangement, a mobile device, a conveyor system, and a method for controlling access in a conveyor system as defined by the respective independent claims.

According to a first aspect, an access control arrangement of a conveyor system, such as of an elevator, an escalator, or a moving walkway, is provided. The conveyor system comprises a manual key-operated access mechanism operable via a keyhole by a key. The access control arrangement comprises a blocking member configured to cover the keyhole in a first position for blocking external access, and to expose the keyhole in a second position, wherein the blocking member is movable between the first position and the second position. The access control arrangement also comprises a communication device for communicating with a mobile device. The access control arrangement is configured to lock the blocking member in the first position, and release the blocking mem-her from the first position in response to receiving a release signal by the communication device.

In some non-limiting examples, the manual key-operated access mechanism of the conveyor system may be arranged onto, such as on the side of the hoistway, or within a landing door(s), and configured to at least unlock, or also open, the landing door(s) when the key is being utilized in connection with, such as when rotated in, the keyhole. On the other hand, the manual key-operated access mechanism, which is different or similar than the above described landing door related key-operated access mechanism, may be arranged coupled to a control unit or panel door of the conveyor, such as to a door or hatch thereof, and configured to at least unlock, or also open, the door or hatch when the key being utilized in connection with the keyhole. The keyhole, and the related structure, is thus, preferably, mechanically coupled to the manual key-operated access mechanism. Thus, in various non-limiting examples, the manual key-operated access mechanism is arranged physically in close connection with the keyhole, for example, so that most of the components of the mechanism are substantially at the same location less than about 1.5 meters away) as the keyhole.

The physical key to the keyhole may be a unique, or al least a semi-unique, key which is adapted to fit only to certain keyhole(s) in connection with manual key-operated access mechanism(s). However, the key may, alternatively, be more like a tool than a key, and the keyhole(s) is/are thus adapted to be operated, such as rotated, by the tool. It may be that the key, especially if it is more like a tool than a conventional (semi-)unique key, it may be easily available for many persons, even if not belonging to the authorized service personnel.

In preferably embodiments, the communication device may be a wireless communication device, and the release signal, in response to the receipt of which the blocking member is released, may be received wirelessly by the wireless communication device. Furthermore, the wireless communication device may be adapted to operate with a signal range extending to an immediate vicinity of the blocking member. Thus, the wireless communication device is preferably arranged to reside substantially in the same location as the blocking member. Thus, in some embodiments, the wireless communication device may be based on a short-range wireless communication technology. Particularly, the wireless communication device may be a Near Field Communication receiver.

Alternatively, the wireless communication device may be a wireless cellular network transceiver. Still, in alternative embodiments, the wireless communication device may be based on WLAN (wireless local area network) of the conveyor system, such as transmitting the release signal via a WLAN Access Point of the conveyor system. Thus, the mobile device may be adapted to be able to communicate with the Access Point. In various embodiments, the wireless cellular network transceiver or the Access Point may be arranged in connection with a conveyor control unit via which the release signal is trans-milled, such as routed, to release the blocking member from the first position.

Furthermore, the access control arrangement may comprise a blocking member locking mechanism arranged to lock the blocking member in the first position.

Alternatively or in addition, the access control arrangement may comprise a controllable actuator arranged in connection with the communication device, and configured to release the blocking member from the first position in response to receiving the release signal by the communication device.

In some embodiments, the controllable actuator may be arranged to operate the blocking member locking mechanism.

In preferable embodiments, the controllable actuator may be disposed substantially in the same location with the blocking member.

In some embodiments, the blocking member may be arranged to be rotated around its rotation axis between the first position and the second position.

In some other embodiments, the blocking member may be arranged to be linearly slid between the first position and the second position.

In various embodiments, the access control arrangement may comprise a notch on a surface in the conveyor system into which the keyhole may be arranged into. The surface including the notch may be a surface of a landing door of the conveyor system, such as of an elevator.

According to a second aspect, a mobile device is provided. The mobile device is configured to operate an access control arrangement in accordance with the first aspect, so as to release the blocking member of the access control arrangement.

The mobile device may, preferably, comprise a wireless transmitter compatible to communicate with the communication device of the access control arrangement. The wireless transmitter may, in some embodiments, be based on short-range wireless communication technology, such as being a Near Field Communication transmitter.

The mobile device may, alternatively or in addition, comprise a wireless cellular network transceiver compatible to communicate with the communication device of the access control arrangement.

Still further, the mobile device may comprise a manually operable interface, such as a touch screen, or a keypad and a display, configured to enable generating the release signal for operating the access control arrangement.

According to a third aspect, a conveyor system is provided. The conveyor system comprises a door or a hatch and a manual key-operated access mechanism operable via a keyhole by a key, wherein the manual key-operated access mechanism is arranged to lock the door or the hatch so as to hinder access via the door or the hatch. The conveyor system further comprises at least one access control arrangement in accordance with the first aspect.

The conveyor system may be, for example, an elevator, an escalator, or a moving walkway.

In preferable embodiments, the conveyor system may be an elevator and comprise plurality of landings with respective landing doors and an elevator car movable between the landings, wherein one of the at least one access control arrangement is disposed to a landing door at one of the landings.

According to a fourth aspect, a method for controlling access in a conveyor system is provided. The conveyor system comprises a manual key-operated access mechanism operable via a keyhole by a key. The method comprises providing a communication device for receiving a communication signal from a mobile device, and providing a blocking member to cover the keyhole in a first position for blocking external access, and to expose the keyhole in a second position, wherein the blocking member is movable between the first position and the second position. The method further comprises configuring the blocking member to be locked in the first position, and to release the blocking member from the first position in response to receiving a release signal by the corn-munication device.

The present invention provides provide an access control arrangement, a mobile device, a conveyor system, and a method for controlling access in a conveyor system. The present invention provides advantages over known solution in that the authorized person can easily gain access to by operating the access control arrangement by a mobile device, for example, while standing in the vicinity of the keyhole in connection with the manual key-operated access mechanism. In the present invention, an authorized maintenance person can provide an authentication code by the mobile device to release the blocking member, thereby ensuring the safety and security even if the key to the keyhole would be widely available. Covering the keyhole by the blocking member also helps to prevent foreign objects from being pushed into the keyhole.

Various other advantages will become clear to a skilled person based on the following detailed description.

The expression “a plurality of” may refer to any positive integer starting from two (2), that is, being at least two.

The terms “first”, “second” etc. are herein used to distinguish one element from (an)other element(s), and not to specially prioritize or order them, if not otherwise explicitly stated.

The exemplary embodiments of the present invention presented herein are not to be in-terpreted to pose limitations to the applicability of the appended claims. The verb “to comprise” is used herein as an open limitation that does not exclude the existence of also unrecited features. The features recited in the dependent claims are mutually freely com-binable unless otherwise explicitly stated.

The novel features which are considered as characteristic of the present invention are set forth in particular in the appended claims. The present invention itself, however, both as to its construction and its method of operation, together with additional objectives and advantages thereof, will be best understood from the following description of specific embodiments when read in connection with the accompanying drawings.

### BRIEF DESCRIPTION OF FIGURES

Some embodiments of the invention are illustrated by way of example, and not by way of limitation, in the figures of the accompanying drawings.

FIG. 1 illustrates schismatically a conveyor system according to an embodiment of the present invention.

FIG. 2 illustrates schematically a conveyor system according to an embodiment of the present invention.

FIG. 3 illustrates schematically a control unit or panel of a conveyor system according to an embodiment of the present invention.

FIG. 4 illustrates schematically a conveyor system and a mobile device according to an embodiment of the present invention.

FIGS. 5A and 5B illustrate schematically an access control arrangement according to an embodiment of the present invention.

FIGS. 6A and 6B illustrate schematically an access control arrangement according to an embodiment of the present invention.

FIG. 7 shows a flow diagram of a method according to an embodiment of the present invention.

### DETAILED DESCRIPTION OF SOME EMBODIMENTS

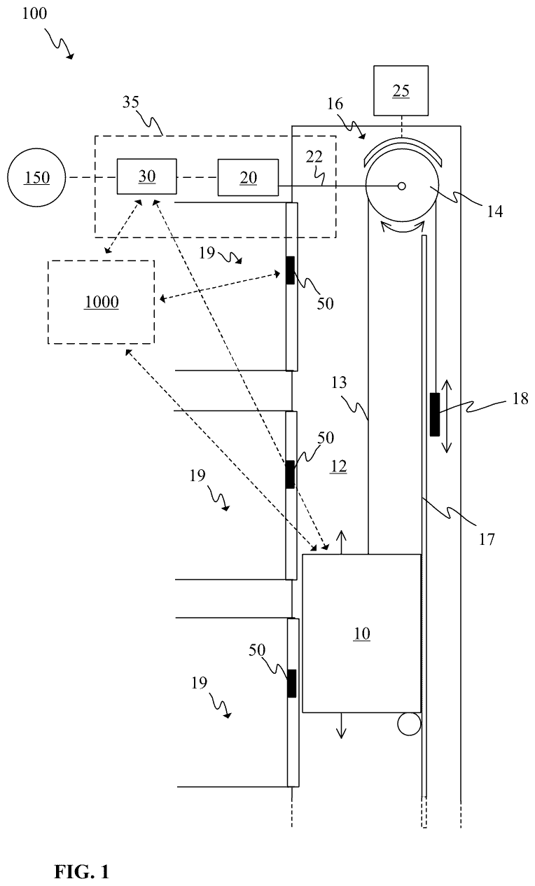

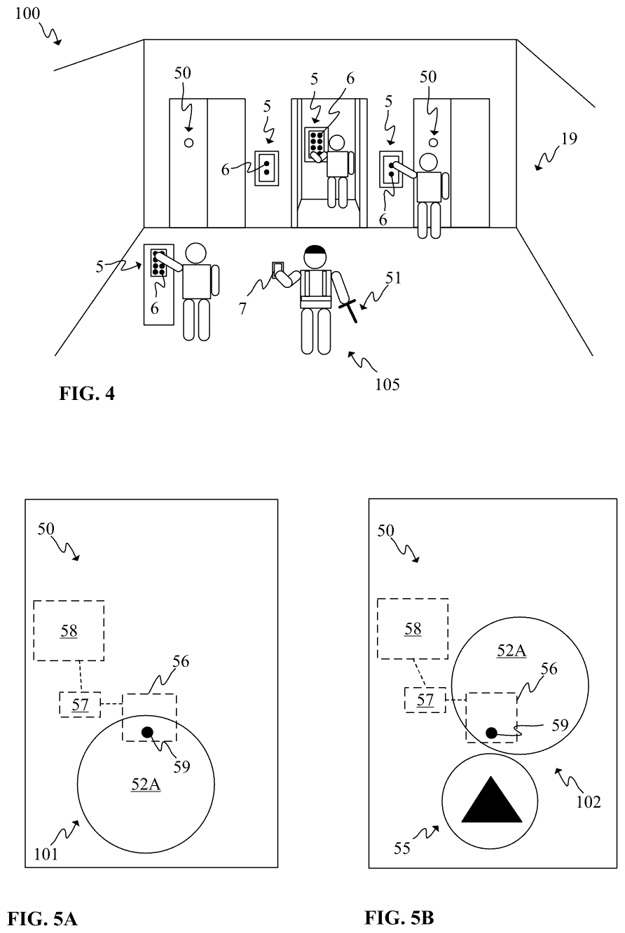

FIG. 1 illustrates schematically a conveyor system according to an embodiment of the present invention. The conveyor system 100 in FIG. 1 is an elevator. The elevator comprises a manual key-operated access mechanism operable via a keyhole by a key. The mechanism may be arranged to control access to hoistway 12 or to control panel of the elevator, for instance, Thus, there may be a door, such as a landing door, or a hatch which may be opened by the mechanism. The elevator also comprises an access control arrangement 50, further details of some embodiments of which will be described hereinbelow with respect to FIGS. 4-6B.

The elevator (single elevator or an elevator group) may comprise an elevator car 10, that is the conveyor of the conveyor system 100, arranged to be moved or movable in an elevator hoistway 12. The moving of the elevator car 10 may be implemented, preferably, by a hoisting rope or belt 13 in connection with a traction sheave 14 or the like. Furthermore, the elevator may comprise an electric motor 20 arranged to operate, such as rotate by the rotor thereof, the traction sheave 14 for moving the elevator car 10, if not essentially directly coupled to the hoisting rope 13. The traction sheave 14 may be connected, via a mechanical connection 22, directly or indirectly via a gear to a shaft of the motor 20. The elevator may comprise a machine room or be machine roomless, such as have the motor 20 in the elevator hoistway 12. There may additionally be, in some embodiments, a counterweight 18 arranged in connection with the elevator car 10 such as is known to a person skilled in the art of elevators.

In some other embodiments, the elevator car 10 may be arranged to be moved by a linear motor comprising a stator beam fixed and extending in the elevator hoistway 12, and at least one mover of the linear motor being coupled to the elevator car 10 for moving thereof.

Still further, the elevator may additionally comprise a guide rail 17 or rails 17 arranged into the elevator hoistway 12 for guiding the movement of the elevator car 10. The elevator car 10 may comprise guide shoes, rollers or the like in moving in contact with the guide rails 17.

The elevator preferably comprise landings 19 or landing floors 19, and, for example, landing floor doors and/or openings, between which the elevator car 10 is arranged to be moved during the normal elevator operation, such as to move persons and/or items between said landings 19. The landings 19 may be served by one or several elevator cars of the elevator.

The elevator may preferably comprise at least one, or at least two, hoisting machinery brake(s) 16 configured for resisting or, preferably, preventing the movement of the motor 20, that is the rotor thereof, directly or via the traction sheave 14 or components thereof and/or therebetween. Furthermore, the elevator 100 may comprise a brake controller 25 configured to operate at least one of the at least one hoisting machinery brake 16. The brake controller 25 may further be in connection with other elements of the elevator, such as an conveyor control unit 1000. The brake controller 25 may comprise an actuator (not shown) for operating the brake 16 or at least be in connection with such an actuator. In case of utilizing linear motor or motors, there may, preferably, also be brake(s) arranged to hold and/or provide deceleration of the elevator car 10.

The elevator may further comprise an electric drive unit 35, such as comprising at least a converter unit 30, for example, including a switched-mode power converter, and preferably the motor 20. The converter unit 30 may be a controllable converter unit 30, such as capable of adapting its input and/or output substantially continuously.

Furthermore, the converter unit 30 may comprise, or substantially be, an inverter or a frequency converter, for connecting to, and controlling the operation of, the motor 20, and a controller in connection with the converter unit 30, wherein the controller is configured to operate the converter unit 30 to provide electrical power (signals), such as having variable voltage and variable frequency, to the electromagnetic components, such as to the windings, of the motor 20. The controller may be a separate controller device or be comprised in the converter unit 30, for instance. In various embodiments, the controller may represent or is included in the conveyor control unit 1000.

Still further, the converter unit 30 may be arranged to be fed by an electrical power source 150, such as of the elevator, for example from an external electrical power grid or mains power supply, or another power source, for example, a battery system. Additionally, the electrical power source 150 may intake electrical power from the converter unit 30.

In various embodiments, the elevator system 110 comprises a conveyor control unit 1000. The conveyor control unit 1000, or in this case an elevator control unit, may be disposed in a control cabinet, at a door frame of a landing 19, or in the door frame. In various embodiments, the conveyor control unit 1000 may be disposed into the control cabinet at the topmost landing 19, such as to a headroom space thereat, or even to a separate machine room at the top of the hoistway 12. The converter unit 30 may be disposed in the elevator hoistway 12 or to the machine room. The converter unit 30 may be arranged to supply power from mains to the electric motor 20 of the hoisting machine to drive an elevator car 10. In case of an elevator utilizing a linear motor for moving the elevator car 10, the converter unit 30 may, alternatively, be arranged to the elevator car 10, for instance.

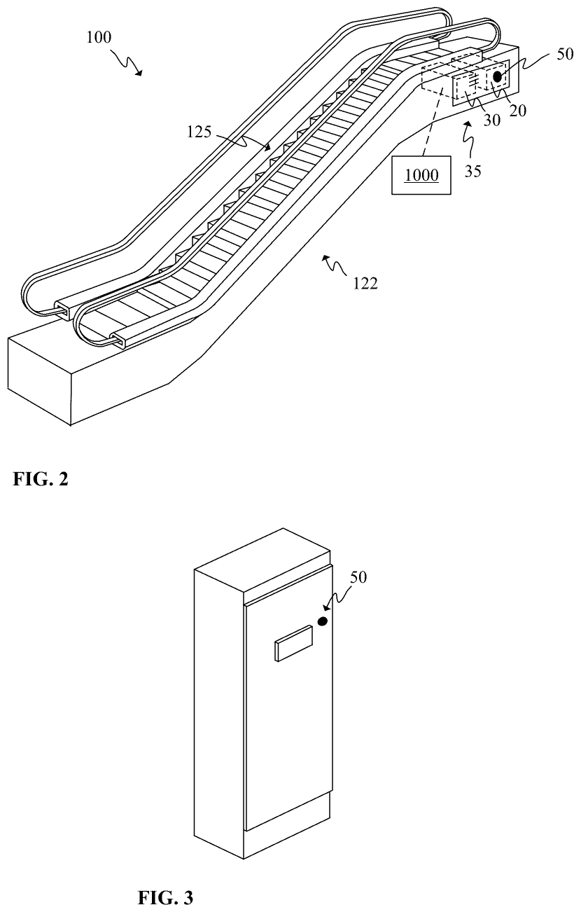

FIG. 2 illustrates schematically a conveyor system 100 according to an embodiment of the present invention. In FIG. 2, the conveyor system 100 is an escalator. The escalator comprises a manual key-operated access mechanism operable via a keyhole by a key.

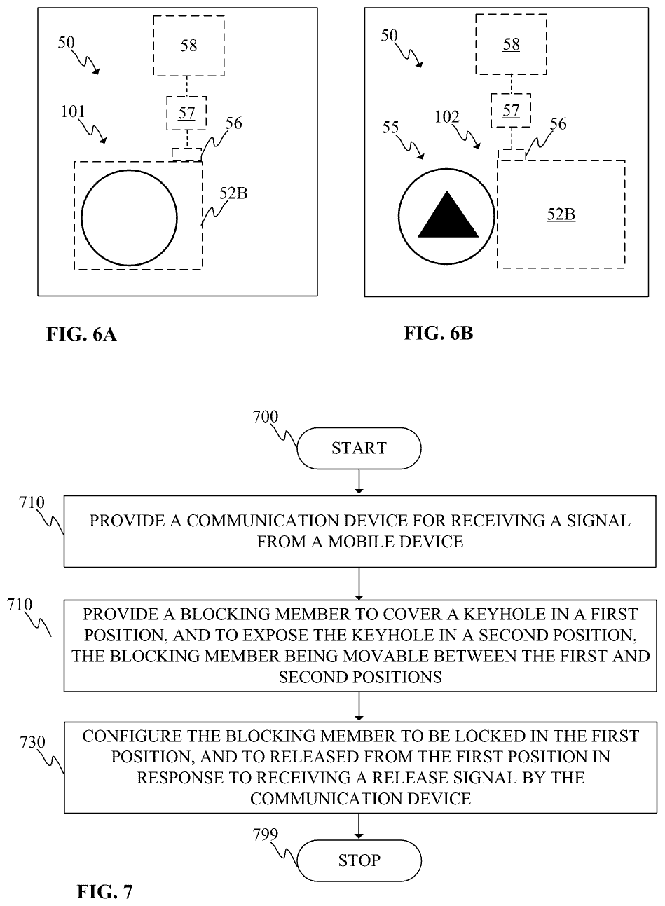

Thus, there may be a door or a hatch, such as of a control unit or panel, which may be opened by the mechanism. The mechanism may be arranged to control access to the control unit or panel, such as to drive unit 35, of the escalator, for instance. The escalator also comprises an access control arrangement 50, further details of some embodiments of which will be described hereinbelow with respect to FIGS. 5A-6B.

The escalator may comprise at least a first, or upper, landing and a second, or lower, landing as well as a drive unit 35 for moving the steps thereof. Furthermore, the escalator preferably comprises a balustrade 122 for supporting the steps 125 and various other components, and other elements of escalators which are known to a skilled person per se, such as moving handrail and components and/or devices related to thereto, and driving means, such as a chain, a drive wheel and/or sprocket, for moving the steps 125 by the drive unit 35. The drive unit 35 may comprise a converter unit 30 and an electric motor 20.

The escalator preferably also comprises a conveyor control unit 1000, such as disposed into the same space with the drive unit 35.

Even though in FIG. 2, the elements of the drive unit 35 are shown to reside at the upper landing, it should be noted that they could, alternatively or in addition, be arranged in various other positions of the system 100 as well.

In accordance with still another embodiment, the conveyor system 100 may be a moving walkway. The moving walkway may be substantially similar to the escalator in FIG. 2 except that there is arranged a moving track instead of the moving steps 125. The moving walkway may comprise at least two landings, a first and a second landing, as well as a drive unit 35 for moving the track thereof. The moving walkway may be horizontal or inclined. The moving walkway may also comprise other elements of moving walkways which are known to a skilled person per se, such as moving handrail and components and devices related to thereto, and means, such as a chain, a drive wheel and/or sprocket, for moving the track by the drive unit 35,

FIG. 3 illustrates schematically a control unit or panel of a conveyor system 100 according to an embodiment of the present invention. The control unit or panel comprises a manual key-operated access mechanism operable via a keyhole by a key. Thus, there may be a door or a hatch, such as of a control unit or panel, which may be opened by the mechanism. The mechanism may be arranged to control access to the control panel or unit, such as to drive unit 35 being disposed therein, for instance. The control unit or panel also comprises an access control arrangement 50, further details of some embodiments of which will be described hereinbelow with respect to FIGS. 5A-6B. Furthermore, the control unit or panel may comprises, as disposed therein, various electrical devices/equipment related to the operation of the conveyor system 100.

FIG. 4 illustrates schematically a conveyor system 100 and a mobile device 7 according to an embodiment of the present invention. In FIG. 4, the conveyor system 100 is an elevator, and there are two manual key-operated access mechanisms arranged to landing floors together with the access control arrangements 50 in accordance with some embodiments of the present invention, in order to control access to the hoistway 12. Alternatively, these could be arranged to landing door frame or top track of the landing door.

The keyhole in connection with the access mechanism may be, for example, arranged into a notch on a surface in the conveyor system 100. The surface may be a surface of a landing door of the conveyor system 100.

The mobile device 7 may configured to operate an access control arrangement 50 so as to release a blocking member (will be described in more detail hereinbelow) of the access control arrangement 50. In various embodiments, the mobile device 7 may be pro-grammed to execute an application software, or an “app”, adapted for generating and transmitting signal(s), such as a release or unlock signal, suitable for operating the access control arrangement 50.

In some embodiments, the mobile device 7 may comprise a wireless transmitter corn-patible to communicate with a communication device (will be described in more detail hereinbelow) of the access control arrangement 50. Yet, in some embodiments, the mobile device 7 may comprise, alternatively or in addition, a wireless cellular network transceiver compatible to communicate with the communication device (will be described in more detail hereinbelow) of the access control arrangement 50.

The mobile device 7 preferably further comprises a manually operable interface, such as a touch screen, and/or a keypad and a display, configured to enable generating signal, such as a release or unlock signal, for operating the access control arrangement 50.

As can be seen, the elevator may be an elevator group in which three elevator hoistways 12 extend via, and the elevator cars 10 moving therein are arranged to serve, the landing 19 shown in FIG. 4.

FIG. 4 also shows a service person 105 at the landing 19 in order to give an example of the utilization of the access control arrangement 50 in accordance with some embodiments of the present invention. The service person 105 is shown to possess a mobile device 7 and a key 51, namely a physical key. The key 51 may be a unique key which is adapted to fit only to certain keyhole(s) in connection with manual key-operated access mechanism(s). However, the key 51 may, alternatively, be more like a tool than a key, and the keyhole(s) is/are thus adapted to be operated, such as rotated, by the tool. It may be that the key, especially if it is more like a tool than a conventional (semi-) unique key, it may be easily available for many persons, even if not belonging to the authorized service personnel.

Furthermore, the elevator system 100 preferably comprises at least one, preferably several, elevator operating devices 5. The elevator operating devices 5 may be, for example, car operating panel(s) inside the elevator car(s), landing call device(s) at the landing(s) 19, and/or destination control panel(s) at the landing(s) 19. Still furthermore, the elevator operating device(s) 5 may comprise at least one, preferably several, elevator buttons 6 comprising a touch surface and configured to generate an elevator call or command in response to operation of the elevator button 6. The elevator call or command may then be provided to a conveyor control unit 1000 for controlling the movement of one or several of the elevator cars 10 in response to the elevator call or command. In some embodiment, also a mobile device (a separate mobile device or the mobile device 7 in accordance with an embodiment of the present invention) may be utilized for providing the elevator call or command wirelessly.

FIGS. 5A and 5B illustrate schematically an access control arrangement 50 according to an embodiment of the present invention. The access control arrangement 50 of the conveyor system 100, which comprises a manual key-operated access mechanism operable via a keyhole 55 by a key 51, comprises a communication device 58 for communi-eating with a mobile device 7, and a blocking member 52A, 52B configured to cover the keyhole 55 in a first position 101 for blocking external access, and to expose the keyhole 55 in a second position 102, wherein the blocking member 52A, 52B is movable between the first position 101 and the second position 102. The access control arrangement 50 is configured to lock the blocking member 52A, 52B in the first position 101, and to release the blocking member 52A, 52B from the first position 101 in response to receiving a release signal by the communication device 58.

In FIGS. 5A and 5B, the blocking member 52A, 52B is arranged to be rotated, manually by the authorized person or automatically by an actuator in response to the release signal, around its rotation axis 59 between the first position 101 and the second position 102.

In various non-limiting examples, a triangular part, such as shown in FIGS. 5A-6B, is a rotatable triangular pin inside the keyhole 55, which the keyhole 55 has a round shape. Thus, the shaft of a key 51 may be introduced into the keyhole 55 such that the triangular pin in the keyhole 55 penetrates into the compatible triangular shaped inner portion of the shaft of the key 51. When the shaft is in its position around the triangular pin, the manual key-operated access mechanism can be operated by turning the key 51, which causes rotating of the triangular pin around its longitudinal axis and manual opening of, for example, the landing door, or other door or hatch of the system 100. However, the keyhole 55 and the key 51 may, alternatively, have different shapes than the ones described herein as is understandable to a skilled person in the art.

FIGS. 6A and 6B illustrate schematically an access control arrangement 50 according to an embodiment of the present invention. In FIGS. 6A and 6B, the blocking member 52A, 52B is arranged to be linearly slid, manually by the authorized person or automatically by an actuator in response to the release signal, between the first position 101 and the second position 102.

In FIGS. 5A and 5B, the blocking member 52A, 52B is shown to reside on the outer side of the element, such as a door or a hatch of the conveyor system 100, to which the blocking member 52A. 52B is arranged to be coupled. In FIGS. 6A and 6B, on the other hand, the blocking member 52A, 52B is arranged to be inside the element and to slide there-within. The blocking member 52A, 52B may, however, be arranged either one of said ways in different embodiments.

Whether in accordance with the one shown in FIGS. 5A and 5B, or with the one shown in FIGS. 6A and 6B, the communication device 58 may be a wireless communication device, and the release signal, in response to the receipt of which the blocking member 52A, 52B is released, may be received wirelessly by the wireless communication device. In some embodiments, the wireless communication device 58 may be adapted to operate with a signal range extending to an immediate vicinity of the blocking member 52A, 52B, such as at most one meter away, or even at most about 30 centimeters away, from the wireless communication device 58. Thus, the wireless communication device 58 may be based on a short-range wireless communication technology. In some preferable embodiments, the wireless communication device may be a Near Field Communication receiver. In some other embodiments, the wireless communication device may be a wireless cellular network transceiver. This way the service person 105 may open the blocking member 52A, 52B while standing next to it.

In various embodiments, the access control arrangement 50 may comprise a blocking member locking mechanism 56 arranged to lock the blocking member 52A, 52B in the first position 101. The locking member locking mechanism 56 may be, for example, any suitable releasable mechanism, such as a movable detent, an electronic lock, a solenoid, a spindle etc.

Alternatively or in addition, the access control arrangement 50 may comprise a controllable actuator 57 arranged in connection with the communication device 58, and configured to release, such as unlock but not necessarily also move, the blocking member 52A, 52B from the first position 101 in response to receiving the release signal, such as wireless release signal, by the communication device 58. However, the controllable actuator 57 may also be arranged to automatically move the blocking member 52A, 52B from the first position 101 in response to receiving the release signal. The controllable actuator 57 may be any compatible actuator, such as a coil, hydraulic circuit, pneumatic circuit, spindle motor, solenoid, electromagnet etc.

The controllable actuator may comprise, or there may be arranged in connection thereto, a controller, such as a microcontroller, which is preferably also in connection with the communication device 58. Upon receipt of the (wireless) release signal, the microcontroller will generate an electrical power signal which is arranged, at least in some embodiments, to cause the controllable actuator 57 to release the blocking member 52A, 52B.

In some embodiments, the controllable actuator 57 may be arranged to operate the blocking member locking mechanism 56.

In various embodiments, the controllable actuator 57 may be disposed substantially in the same location with the blocking member 52A, 52B, as depicted in FIGS. 5A-6B. The same location may refer to same element onto which these components are arranged to and/or maximum distance of one meter or so.

FIG. 7 shows a flow diagram of a method according to an embodiment of the present invention.

Item 700 refers to a start-up phase of the method. Suitable equipment and components are obtained and systems assembled and configured for operation. For example, a conveyor system 100 and/or a control unit or panel thereof may be installed and prepared for operation, such as illustrated in and discussed in connection with FIGS. 1-4.

Item 710 refers to providing a communication device 57 for receiving a communication signal from a mobile device 7. The communication device 57, for example, a Near Field Communication receiver, may be arranged in connection with an element of the conveyor system 100, such to a landing door of an elevator, or to a door or hatch of a control unit or panel of the conveyor 100, The communication signal may be, for example, the release signal.

Item 720 refers to providing a blocking member 52A, 52B to cover the keyhole 55 in a first position 101 for blocking external access, and to expose the keyhole 55 in a second position 102, wherein the blocking member 52A, 52B is movable between the first position 101 and the second position 102.

Item 730 refers to configuring the blocking member 52A, 52B to bed locked in the first position 101, and to release the blocking member 52A, 52B from the first position 101 in response to receiving a release signal by the communication device 57.

Method execution may be stopped at step 799. Thus, for example, an access control arrangement 50 in accordance with FIGS. 5A and 5B, or with FIGS. 6A and 6B is provided for controlling access in a conveyor system 100.

In some embodiments, the method further comprises transmitting the release signal wirelessly by the mobile device 7 so as to release the blocking member 52A, 52B from the first position 101.

1. An access control arrangement of a conveyor system, the conveyor system comprising a manual key-operated access mechanism operable via a keyhole by a key, the access control arrangement comprising:
a communication device for communicating with a mobile device; and
a blocking member configured to cover the keyhole in a first position for blocking external access, and to expose the keyhole in a second position, wherein the blocking member is movable between the first position and the second position,
wherein the access control arrangement is configured to:
lock the blocking member in the first position, and
release the blocking member from the first position in response to receiving a release signal by the communication device.

2. The access control arrangement of claim 1, wherein the communication device is a wireless communication device, and the release signal, in response to the receipt of which the blocking member is released, is received wirelessly by the wireless communication device.

3. The access control arrangement of claim 2, wherein the wireless communication device is adapted to operate with a signal range extending to an immediate vicinity of the blocking member.

4. The access control arrangement of claim 2, wherein the wireless communication device is based on a short-range wireless communication technology.

5. The access control arrangement of claim 2, wherein the wireless communication device is a Near Field Communication receiver.

6. The access control arrangement of claim 2, wherein the wireless communication device is a wireless cellular network transceiver.

7. The access control arrangement of claim 1, comprising a blocking member locking mechanism arranged to lock the blocking member in the first position.

8. The access control arrangement of claim 1, comprising a controllable actuator arranged in connection with the communication device, and configured to release the blocking member from the first position in response to receiving the release signal by the communication device.

9. The access control arrangement of claim 7, wherein the controllable actuator is arranged to operate the blocking member locking mechanism.

10. The access control arrangement of claim 8, wherein the controllable actuator is disposed substantially in the same location with the blocking member.

11. The access control arrangement of claim 1, wherein the blocking member is arranged to be rotated around a rotation axis thereof between the first position and the second position.

12. The access control arrangement of claim 1, wherein the blocking member is arranged to be linearly slid between the first position and the second position.

13. The access control arrangement of claim 1, comprising a notch on a surface in the conveyor system into which the keyhole is arranged.

14. The access control arrangement of claim 13, wherein the surface is a surface of a landing door of the conveyor system.

15. A mobile device configured to operate the access control arrangement of claim 1, so as to release the blocking member of the access control arrangement.

16. The mobile device of claim 15, comprising a wireless transmitter compatible to communicate with the communication device of the access control arrangement.

17. The mobile device of claim 15, comprising a wireless cellular network transceiver compatible to communicate with the communication device of the access control arrangement.

18. The mobile device of claim 15, comprising a manually operable interface configured to enable generating the release signal for operating the access control arrangement.

19. A conveyor system, comprising:
a door or a hatch;
a manual key-operated access mechanism operable via a keyhole by a key, wherein the manual key-operated access mechanism is arranged to lock the door or the hatch so as to hinder access via the door or the hatch; and
at least one of the access control arrangement of claim 1.

20. The conveyor system of claim 19, being an elevator, an escalator, or a moving walkway.

21. The conveyor system of claim 19, comprising a plurality of landings with respective landing doors and an elevator car movable between the landings, wherein one of the at least one access control arrangement is disposed to a landing door at one of the landings.

22. A method for controlling access in a conveyor system, the conveyor system comprising a manual key-operated access mechanism operable via a keyhole by a key, the method comprising:
providing a communication device for receiving a communication signal from a mobile device;
providing a blocking member to cover the keyhole in a first position for blocking external access, and to expose the keyhole in a second position, wherein the blocking member is movable between the first position and the second position; and
configuring the blocking member to be locked in the first position, and to release the blocking member from the first position in response to receiving a release signal by the communication device.

23. The method of claim 22, comprising transmitting the release signal wirelessly by the mobile device so as to release the blocking member from the first position.
